(19) United States
(12) Patent Application Publication
(10) Pub. No.: US 2016/0297096 A1
(43) Pub. Date: Oct. 13, 2016

(54) SCATTERING HEAD, PROCESS AND PANEL

(71) Applicant: MAYFAIR VERMÖGENSVERWALTUNGS SE, Hamburg (DE)

(72) Inventor: Jeroen Nijsse, Hoedekenskerke (NL)

(21) Appl. No.: 15/092,771

(22) Filed: Apr. 7, 2016

(30) Foreign Application Priority Data
Apr. 10, 2015 (DE) 102015206469.7
May 28, 2015 (DE) 102015209759.5

(51) Int. Cl. B27N 3/14; B27N 3/06; B32B 27/10; B27N 3/02

(52) U.S. Cl. CPC B27N 3/14; B27N 3/02; B27N 3/06; B32B 27/10; B32B 2262/067; B32B 2307/72; B32B 2607/00

(57) ABSTRACT

The disclosure relates to a process for producing a panel, to a panel produced by the process and also to a scattering head and an outer-layer scattering head for producing a panel on the basis of cereal crops. A scattering head with pairs of smooth rollers and planetary rollers directly adjacent one another allows both long and short stalk half shells to be scattered homogeneously onto a conveyor belt over the entire length of the scattering head. Paddle wheels provide a transverse orientation, in particular in the case of long stalk half shells. Panels with a high density, low variation in density in the longitudinal direction and a smooth surface can thus be produced.

### FIELD OF THE DISCLOSURE

The present disclosure relates generally to panels, and more specifically to a process for producing a panel, to a panel and to a scattering head and an outer-layer scattering head for producing a panel on the basis of cereal crops.

### BACKGROUND

Panels on the basis of cereal crops such as straw or reed have the advantage over conventional particle boards, OSB or MDF panels made of wood flakes, wood chips or wood particles that agricultural waste products can be used as raw materials instead of trees. However, on account of the long, thin stalk-like structure, the processing of cereal crops is much more difficult than the processing of wood. Furthermore, in order that panels on the basis of cereal crops can establish themselves on the market as opposed to the conventional wood-based panels, the production methods have to be further developed in such a way that panels on the basis of cereal crops can be produced with properties that have advantages in certain aspects over wood-based panels.

Problems with today's wood-based panels arise for example because of the rough surfaces after production, as a result of which wood particle boards or veneer are usually used as an intermediate layer, in order to obtain a sufficiently smooth surface for applying printable kraft paper. However, such an intermediate layer means that production involves more expenditure and, due to the different moisture contents, presents problems in the form of deformations of the end product over time or when there are changes in interior ambient conditions. A disadvantage of particle boards is the relatively high weight, which makes handling more difficult.

A production plant for producing a panel on the basis of cereal crops is complex, elaborate and cost-intensive due to many interlinked process stations and an elaborate material transporting system between the process stations, for example on the basis of an airflow channel. However, to meet the demands of the market, it is not sufficient just to be able to produce a single type of panel with the same kind of material, the same layer structure and the same layer characteristics in a production plant. Greater flexibility with regard to the panels that can be produced in the same production plant with respect to the processable lengths and distributions of lengths of the material from cereal crops, that is to say pieces of stalk, over the cross section of a panel and also with regard to the layer structure of a panel may be helpful for profitable production.

However, the scattering heads that are known at present are not capable of processing both material batches of long pieces of stalk with a length of up to 150 mm as well as material batches with short pieces of stalk with a length of less than 4 mm. This is so because short pieces of stalk fall more easily through small openings and can so far only be inadequately distributed in the conveyor-belt direction and scattered on the conveyor belt by scattering heads that can also process long pieces of stalk. This results in a high throughput of short pieces of stalk in the middle of the scattering head, and the formation of a hump thereby caused in the mat of scattered material on the conveyor belt, with the consequence of inhomogeneously created panels with inclusions and a great variation in density in the longitudinal direction.

Scattering heads for producing boards and boards made of different renewable raw materials are dealt with in the documents CA02296554C, WO0202886 and EP0860255A1. The aforementioned features that are known from the prior art can be combined individually or in any desired combination with one of the subjects according to the disclosure that are described below. Similarly, the embodiments and features described hereinafter can be combined as desired to form new embodiments.

Therefore, the object of the disclosure is to provide further developed production processes and devices and also further developed panels.

### SUMMARY

Serving to achieve the object are a process for producing a panel, a panel and also a scattering head and an outer-layer scattering head for producing a panel on the basis of cereal crops.

The object is achieved by a process for producing a panel, wherein first stalks of one or more cereal crops, such as straw and/or reed, are preferably shortened and for the greatest part, or to a proportion of over 80%, split in the longitudinal direction of the stalk in order to obtain elongate, approximately half-shell-shaped stalk half shells, which are then provided with binder and scattered by a scattering head onto a conveyor belt running in the conveyor-belt direction, in order to build up there a mat of scattered material or a layer of a mat of scattered material of the stalk half shells, which is subsequently pressed under the effect of heat in order to obtain an unworked panel for use as a construction board or a further-processed panel, for example for use as a floor covering or for the production of furniture, wherein the stalk half shells are fed through a material inflow unit of the scattering head from above onto an upper side of a series of rollers with conveying rollers of the scattering head arranged one behind the other in the series-of-rollers conveying direction and transported from there along the upper side of the series of rollers directly on the rotating conveying rollers in the series-of-rollers conveying direction, part of the stalk half shells in each case passing through the series of rollers downward in the direction of the conveyor belt during the transportation along the upper side of the series of rollers, through a number of vertical passages distributed in the series-of-rollers conveying direction, each vertical passage periodically opening and closing, and wherein a substantially rectangular vertical passage opening that continuously increases in size, decreases in size and closes, in order to transport only part of the stalk half shells downward through the series of rollers, is provided over an entire width of the series of rollers.

The object is likewise achieved by a scattering head, in particular for carrying out the process described above, for scattering elongate stalk half shells from a cereal crop onto a conveyor belt for producing a panel, with a material inflow unit and a series of rollers with conveying rollers arranged one behind the other, the conveying rollers alternately having a rotationally symmetrical lateral surface and a non-rotationally symmetrical lateral surface with depressions and/or elevations.

Conveying rollers with an alternately rotationally symmetrical and non-rotationally symmetrical lateral surface allow a planned reduced passing-through of stalk half shells through the series of rollers downward in the direction of the conveyor belt to be achieved, and consequently a particularly homogeneous distribution even of short stalk half shells over the entire series of rollers to be made possible. In particular, opening and closing vertical passages can thus be formed in a particularly easy way.

In particular, the scattering head is a scattering head for scattering elongate, approximately half-shell-shaped stalk half shells provided with binder onto a conveyor belt running in the conveyor-belt direction for producing an unworked panel for use as a construction board or a further-processed panel, for example for use as a floor covering or for the production of furniture, wherein stalks of one or more cereal crops, such as straw and/or reed, are preferably shortened and for the greatest part, or to a proportion of over 80%, split in the longitudinal direction of the stalk to produce the stalk half shells, with a material inflow unit, a series of rollers with conveying rollers arranged one behind the other that can rotate in only one series-of-rollers conveying direction of the series of rollers for transporting stalk half shells, and a number of vertical passages distributed in the series-of-rollers conveying direction that are designed such that the stalk half shells can be fed through the material inflow unit from above onto an upper side of the series of rollers and from there can be transported along the upper side of the series of rollers directly onto the rotating conveying rollers in the series-of-rollers conveying direction, in each case part of the stalk half shells being able to pass through the vertical passages downward in the direction of the conveyor belt during the transportation along the upper side of the series of rollers, each vertical passage being able to open and close periodically and being able to provide a substantially rectangular vertical passage opening that can continuously increase in size, decrease in size and close, in order to transport only part of the stalk half shells downward through the series of rollers, over an entire width of the series of rollers.

The following description relates both to the process according to the disclosure and to the scattering head according to the disclosure.

In this document, cereal crops mean those plants that have a stalk structure. Stalk means a stalk or stem with a form that has grown longitudinally and is approximately cylindrical, a fiber alignment in the longitudinal direction often existing in the case of a stalk or a stalk structure. Straw and reed have such stalks. Unless otherwise specified, a proportion of stalk half shells means proportions in percent by weight.

A splitting of the stalks in the longitudinal direction of the stalk to obtain stalk half shells may be performed for example by chipping machines specially adapted for the processing of straw and reed. Compared with non-split stalks, stalk half shells have particularly high binder adherence and can be processed into panels with particularly high density and few inclusions.

An unworked panel is a board with unworked surfaces after hot pressing, that is to say without for example sanding, coating, etc., and as such can be used as a construction board for structural work and interior design. A further-processed panel is an unworked panel which, for example after removal of material, by for example sanding, coating, by for example applying a strong paper, decorative paper and/or a transparent top protective layer, can be used as a floor covering or a wall covering for interior design.

The process according to the disclosure and/or the scattering head according to the disclosure allow(s) panels with densities of at least 400 kg/m³ and/or at most 950 kg/m³ to be produced.

In particular, it is possible to produce a panel designed such that it can meet the mechanical requirements for an OSB/1 board for interior design, including furniture for use in the dry area, OSB/2, OSB/3 for boards for load-bearing purposes for use in the wet area and/or OSB/4 for enhanced load-bearing uses according to the standard EN 300. Such a panel preferably has a density of at least 520 kg/m³ and/or at most 950 kg/m³, with preference at most 720 kg/m³. For example, in the case of a panel at the lower density limit, the OSB/4 standard can likewise be met by a high proportion of binder.

In particular, it is possible to produce a panel designed such that it can meet the mechanical requirements for a particle board of class P1, P3, P5 and/or P7 according to the standard EN 312. Such a panel preferably has a density of at least 570 kg/m³ and/or at most 950 kg/m³, with preference at most 680 kg/m³. For example, in the case of a panel at the lower density limit, the P7 standard can likewise be met by a high proportion of binder.

All of the relevant mechanical characteristic values mentioned in this application relate to the same standards—specified at a point in this document—to be precise in the versions of these standards on the priority date.

Mechanical requirements or load-bearing capacity comprise(s) in particular the bending strength in the major axis, the bending strength in the minor axis, the modulus of elasticity (MOE) in the major axis, the modulus of elasticity in the minor axis, the transverse tensile strength (internal bond strength), the bending strength in the major axis after a cyclic test, the transverse tensile strength after a cyclic test and/or the transverse tensile strength after a boil test.

In particular, it is possible to produce a panel designed such that it can satisfy at least one or all of the values or ranges of values of the load-bearing capacity that are specified below in connection with the panel according to a further aspect of the disclosure that can be produced by this process.

As a difference from wood-based panels, panels on the basis of straw and/or reed with straw half shells with a length less than 4 mm to a proportion of up to 80% can be produced with the process according to the disclosure and/or the scattering head according to the disclosure. A panel that can be produced in this way may have a homogeneous density distribution with a standard deviation of at most 20%, with preference 15%, with particular preference 10%, over the longitudinal extent of the panel. The surface of the panel is so smooth that, after only slight sanding of the surfaces, a printable and later visible melamine-impregnated kraft paper can already be applied directly to the otherwise untreated surface directly by means of pressing under the influence of heat.

In the case of wood-based OSB panels, the surface is very rough, so that usually an intermediate layer is located between the surface of the panel and the later visible kraft paper for the purpose of smoothing. This additional intermediate layer may be an additional wood particle board or a veneer, that is to say sheets of wood about 0.3 mm to 6 mm thick that are detached from a tree trunk by various sawing and cutting processes. This is not only very laborious in production, but often presents problems of deformation due to the differing moisture contents of the various layers of wood board. The panels that can now be produced on the basis of straw and/or reed allow the expenditure involved in production to be reduced, and the deformation problems described above to be reduced.

The panels that can now be produced have the advantage over wood particle boards that the mechanical requirements of a class, for example P1, P3, P5 or P7, can be achieved with particularly low density. The panel is therefore particularly lightweight in comparison with particle boards and as a result can be handled particularly well. Moreover, use of only little material is required for production in comparison with wood particle boards.

The upper side of a series of rollers means the side facing the material inflow unit. In principle, the upper side comprises the entire visible surface in plan view, irrespective of whether the conveying rollers are rotating or stationary. The series-of-rollers conveying direction is oriented transversely in relation to the conveying roller axes, the conveying roller axes of all the conveying rollers being arranged regularly in parallel.

Transported along the upper side of the series of rollers directly on the conveying rollers in the series-of-rollers conveying direction means that the stalk half shells are moved on the upper side from one conveying roller to the next, and thereby always remain on the upper side, without appreciable amounts of stalk half shells passing unplanned between two neighboring conveying rollers downward through a closing gap into the region under the series of rollers. The width of the series of rollers extends along the conveying roller axis—that is to say transversely to the series-of-rollers conveying direction—and comprises the region of the series of rollers that can come into contact with the stalk half shells.

With the exception of the beginning and the end of the series of rollers, planned passing of the stalk half shells from the upper side of the series of rollers through the series of rollers into the region under the series of rollers is intended exclusively between two neighboring conveying rollers or through the periodically opening and closing vertical passages that provide a vertical passage opening that continuously increases in size, decreases in size and closes during operation. A closed vertical passage, that is to say a closed vertical passage opening, is not tightly closed, but like the neighboring conveying rollers has a closing gap that is so narrow that a collision of the conveying rollers can be reliably avoided and at the same time no appreciable amounts of stalk half shells can pass unplanned downward through a closing gap.

In the case of a closed vertical passage or between the effective circles of two neighboring conveying rollers, such a closing gap may for example have a closing gap width of at least 0.1 mm, with preference 0.5 mm, with particular preference 1 mm and/or at most 4 mm, with preference at most 3 mm, with particular preference 2 mm. An effective circle of a conveying roller should be understood as meaning the circle with an outside diameter that corresponds to the circumference of the outermost extent of the conveying roller cross section—transversely in relation to the conveying roller axis—, the outermost extent generally being a non-rotationally symmetrical elevation.

The process according to the disclosure and/or the scattering head according to the disclosure allow(s) particularly homogeneous distribution and scattering of the stalk half shells over the entire surface of the series of rollers onto the conveyor belt, and consequently a homogeneous scattered material mat with low variations in density in the longitudinal direction, that is to say the conveyor-belt direction, to be achieved. In addition, a first pre-orientation of the stalk half shells transversely in relation to the conveyor-belt direction can be achieved in particular by the substantially rectangular transverse extent of the vertical passage opening.

It is also a great advantage that the process according to the disclosure and/or the scattering head according to dimension now allow long stalk half shells with a length of up to 150 mm as well as short stalk half shells with a length of less than 4 mm to be reliably and efficiently built up into a homogeneous mat of scattered material with low density variation in the conveyor-belt direction. Production of high-quality and in particular load-bearing panels on the basis of straw and/or reed can thus be made possible.

The fact that long and short stalk half shells can be processed means that flexible production of panels with different length distributions of the stalk half shells by the same production line is made possible. Panels with different characteristics and properties can in this way be produced while involving particularly little production expenditure and production can be changed over to producing the various types of panel particularly quickly and with only little expenditure.

The following embodiments and further developments concern both the process and the scattering head.

With preference, in the case of the process and/or the scattering head, in a series of rollers all of the conveying rollers arranged between a second and a last-but-one conveying roller are arranged directly adjacent one another, that is to say arranged at the distance of a closing gap from one another, and/or a coinciding direction of rotation is provided for conveying the stalk half shells in the series-of-rollers conveying direction, in particular about a conveying roller axes oriented transversely in relation to the conveyor-belt direction. In particular, the conveying rollers are also arranged approximately centered with respect to the conveyor belt in the direction of the axis of rotation. Effective distribution can thus be achieved and unplanned movement of stalk half shells downward through the series of rollers can be counteracted.

It is preferred in the case of the process and/or the scattering head that a conveying roller with a rotationally symmetrical lateral surface is a smooth roller and a conveying roller with a non-rotationally symmetrical lateral surface with depressions and/or elevations is a planetary roller, preferably with a number of planetary cylinders as elevations on a lateral surface of a main cylinder; and/or a periodically opening and closing vertical passage comprises or consists of two conveying rollers directly adjacent one another, one conveying roller being a smooth roller and/or the other conveying roller being a planetary roller.

A smooth roller has the form of a cylinder with a smooth lateral surface that is symmetrical to the conveying roller axis. A planetary roller comprises a main cylinder with the form of a cylinder with a smooth lateral surface and also at least two cylindrical planetary cylinders, which are aligned parallel to the main cylinder, in particular are smooth and have the same outside diameter, the planetary cylinders having a smaller outside diameter than the main cylinder and being firmly connected to the lateral surface of the main cylinder.

The form of a cylinder means a cylinder with a circular cross section. A smooth lateral surface means that the lateral surface, that is to say the outer surface or circumferential surface of the cylinder, does not have any planned depressions or elevations, but merely a roughness within the limits of production tolerances. Aligned in parallel means oriented in parallel in relation to the conveying roller axis. Firmly connected to the lateral surface of the main cylinder means so firmly connected, for example by a welded connection or screw connection, that no relative movement and no loosening of the connection is to be expected during operation.

The form of a cylinder means a rotationally symmetrical, circular form of a cylinder. A smooth lateral surface means that the effective circle during rotation corresponds substantially to the diameter of the cylinder, that is to say no outer profile with radial elevations in the circumferential direction and over the width of the conveying roller are provided and the surface roughness is within the limits of the usual production tolerances.

The interaction of a smooth roller and a planetary roller allows long and short stalk half shells to be processed equally reliably and effectively, this is to say scattered downward homogeneously over the surface of the series of rollers. The stalk half shells are generally transported as sizeable loose accumulations of material onto the series of rollers by way of the material inflow unit, so that a thick layer of stalk half shells builds up on the series of rollers. Long stalk half shells are pressed by the planetary cylinders in the series-of-rollers conveying direction without necessarily being drawn into the vertical passage opening, as would often be the case with radial plates or paddles.

Depending on the distance from the main cylinder of the planetary roller, short stalk half shells in the buildup on the series of rollers are either displaced upward by the planetary cylinders as a result of the cylinder form or are conveyed in the direction of the main roller. As a result, only part of the built-up stalk half shells at a smaller distance from the main cylinder of the rotating planetary roller is transported downward. The rest of the stalk half shells continues to be moved in the series-of-rollers conveying direction.

A person skilled in the art would entirely forego the use of smooth rollers for transporting stalk half shells, because they do not have any entraining contour or elevations for effectively transporting in the series-of-rollers conveying direction for lack of a surface structure or surface profile. When using smooth rollers, stalk half shells can only be moved in the direction of rotation of the smooth roller, that is to say in the series-of-rollers conveying direction, by surface friction with the lateral surface of the smooth roller. Long stalk half shells, which build up in a way similar to straw bales and only make contact with the smooth roller at the pointed ends of the stalk half shells, can only be further transported, that is to say conveyed, a little or not at all by smooth rollers for lack of sufficient frictional forces.

The distance between two planetary rollers, which is determined by the outside diameter of the smooth roller lying in between, can however be bridged in the case of long stalk half shells by the conveying action of the planetary rollers, in that the long stalk half shells are pressed upward or obliquely upward in the series-of-rollers conveying direction by the cylinder form of the planetary cylinders, so that they enter the region of influence of the next planetary roller, and can thus be transported in the series-of-rollers conveying direction, even without a conveying action of the smooth roller lying in between. Depending on the diameter of the smooth roller, this effect is increased by the stalk half shells that have built up on the series of rollers also being mechanically loosely connected to one another or hooked within one another like hay bales. This allows a compressive movement by a planetary roller to be transferred by this loose interconnection to the built-up stalk half shells, so that smooth rollers with a greater diameter can also be bridged to a certain extent. In the case of short stalk half shells, the planar bearing contact on the smooth roller is generally adequate to achieve sufficient frictional forces for conveyance.

Consequently, the distances between the vertical passages—that is to say the points at which stalk half shells can be transported or allowed to pass through downward as planned—can be fixed by the choice of diameter of the smooth roller, and thus particularly uniform distribution can be achieved even of short stalk half shells over the entire length of the series of rollers in the series-of-rollers conveying direction.

Planetary cylinders have the further advantage in the case of long stalk half shells that a first transverse orientation of the stalk half shells can already take place, that is to say transversely in relation to the series-of-rollers conveying direction or the conveyor-belt direction. This is so because, as a result of the rounding, obliquely oriented stalk half shells are smoothly and continuously introduced by the planetary cylinders into the v-shaped pocket that is formed by the planetary cylinder and the lateral surface of the main cylinder, or are pressed in as a result of the rotation.

In this way, particularly effective and homogeneous scattering in the series-of-rollers conveying direction of both short and long stalk half shells by the same production plant can be made possible.

In particular, the smooth roller, the main cylinder and/or the planetary cylinders all have the same width, in particular the same width as the entire width of the series of rollers. What is meant by width here is only the part of the smooth roller, the main cylinder and the planetary cylinder that comes into contact with stalk half shells. Preferably, the main cylinder has the same form as the smooth roller, while the outside diameter may vary. In particular, the cross section of a smooth roller and/or planetary cylinder roller is identical and unchanged over the entire width of the series of rollers.

With preference, in the case of the process and/or the scattering head, at least four, preferably six, with particular preference eight, and/or at most fourteen, preferably twelve, with particular preference ten, planetary cylinders are provided and/or the planetary cylinders are distributed at equal distances over the circumference of the main cylinder of the planetary roller, that is to say are connected at the same angular distance from one another to the lateral surface of the main cylinder of the planetary roller. The angular distance means the angular difference with respect to the conveying roller axis.

Particularly effective conveyance of short and long stalk half shells and also particularly homogeneous and uniform distribution over the length of the series of rollers can thus be achieved.

It is preferred in the case of the process and/or the scattering head that a smooth roller and a planetary roller have a substantially equal outside diameter and/or a main cylinder of a planetary roller has in comparison with planetary cylinders of the planetary roller a diameter that is at least three times, with preference four times, with particular preference four and a half times, as large, and/or at most seven times, with preference six times, with particular preference five times, as large. Preferably, the diameter of the smooth roller is at least 80 mm, with preference 100 mm, with particular preference 120 mm, and/or at most 170 mm, with preference 150 mm, with particular preference 130 mm. Preferably, the diameter of the main cylinder is at least 75 mm, with preference 80 mm, with particular preference 85 mm, and/or at most 110 mm, with preference 100 mm, with particular preference 90 mm. Preferably, the diameter of the planetary cylinder is at least 5 mm, with preference 10 mm, with particular preference 15 mm, and/or at most 40 mm, with preference 30 mm, with particular preference 20 mm.

The outside diameter in the case of a planetary roller means the effective circle, that is to say generally the sum of the diameters of the main cylinder and two planetary cylinders. Substantially the same outside diameter allows for example a deviation of altogether 2%, with preference 5%, with particular preference 10%.

Particularly effective conveyance of short and long stalk half shells and also particularly homogeneous and uniform distribution over the length of the series of rollers can thus be achieved.

It is preferred in the case of the process and/or the scattering head that in a series of rollers at least three, four or five and/or at most eight, seven or six pairs of rollers arranged directly one behind the other are provided, comprising or consisting of a smooth roller and a planetary roller. Preferably, altogether precisely five smooth rollers and precisely four planetary rollers are arranged in a series of rollers, arranged alternately.

As a result, a distribution or scattering of long and short stalk half shells that is particularly homogeneous over the length of the series of rollers is made possible.

It is preferred in the case of the process and/or the scattering head that two series of rollers arranged mirror-symmetrically about a middle plane of the scattering head are provided, the material inflow unit is arranged centrally or mirror-symmetrically in relation to the middle plane of the scattering head and/or the series-of-rollers conveying direction and the direction of rotation of the conveying rollers are directed outwardly, as seen from the material inflow unit.

A particularly high material throughput of the production plant can be made possible by these preferred further developments. The stalk half shells can thus pass through the material inflow unit as loosely interconnected buildups onto the two upper ends of the two mirror-symmetrical series of rollers, where the conveying rollers to the left of the middle plane rotate counterclockwise for a leftwardly directed series-of-rollers conveying direction and the conveying rollers to the right of the middle plane rotate clockwise for a rightwardly directed series-of-rollers conveying direction. With increasing length of the series of rollers, the difficulty of homogeneous downward scattering of the stalk half shells increases. Consequently, dividing the stalk half shells over two series of rollers doubles the material throughflow with the same high scattering quality and a high proportion of transversely oriented stalk half shells in comparison with only one series of rollers.

It is preferred in the case of the process and/or the scattering head that the series of rollers arranged at an acute angle and/or the material inflow unit overlies an upper end of the series of rollers from above.

An acute angle means an angle less than 90°, with preference less than 60°, with particular preference less than 45°, in relation to a horizontal that is oriented parallel to the conveyor belt.

The arrangement of the series of rollers at an acute angle and/or the arrangement of the material inflow unit above the upper end of the series of rollers allow(s) the stalk half shells to be transported particularly quickly over the entire length of the series of rollers to the lower end of the series of rollers, and consequently to be achieved with a particularly great material throughput and efficiency of the plant.

It is preferred in the case of the process and/or the scattering head that a porcupine roller with at least 1000 and/or at most 1500 radial spikes is provided as a first conveying roller, in particular only the first conveying roller of the series of rollers, the effective circle of the porcupine roller being at least 50% greater and/or at most twice as great as the effective circle or diameter of the other conveying rollers, in particular the smooth roller or the planetary roller, and a proportion on the effective circle of at least 20% and/or at most 30% being assignable to the radial spikes or the length of the radial spikes. The radial spikes are preferably arranged in at least 15 and/or at most 25 rows distributed uniformly over the circumference of the cylinder roller, in each rows oriented parallel to the axis of the conveying roller a radial spike being arranged on the cylinder roller, at least at a distance of at least 10 mm and/or at most 30 mm. Preferably, each radial spike is fastened firmly and oriented radially on a lateral surface of the cylinder roller, in particular by a welded connection. The diameter of a radial spike may be at least 5 mm, with preference 7 mm, and/or at most 11 mm, with preference 9 mm. A first conveying roller is the first conveying roller in the series of rollers at one end or the upper end that is facing the material inflow unit.

The provision of a porcupine roller with such a large number of densely arranged, short radial spikes on a cylinder roller with a greater diameter than the rest of the conveying rollers of the series of rollers allows the performance of particularly effective separation of the loosely interconnected buildups of the stalk half shells that fall down from the material inflow unit onto the porcupine roller. With fewer or longer radial spikes, the buildups would be separated less effectively and homogeneous distribution over the entire length of the series of rollers would be made more difficult. With more radial spikes, there would be the risk of both short and long stalk half shells becoming lodged between the radial spikes.

It is preferred in the case of the process and/or the scattering head that the one or more series of rollers is underlaid by a—in particular only one—series of paddle wheels with paddle wheels directly adjacent one another, which is preferably horizontally aligned, the paddle wheels, nine in particular and preferably of an identical construction, preferably comprising at least fifteen and/or at most twenty transverse pockets extending parallel to a paddle wheel axis, which are respectively formed by two V-shaped paddles and part of a lateral surface of a cylinder roller, each paddle being oriented with an open side of the V-shaped paddle in the direction of rotation and connected with one end at an acute angle, preferably of at least 60° and/or at most 90°, to the lateral surface of the cylinder roller, in particular by a welded connection. In particular, the V-shaped paddle likewise forms an acute angle of at least 45° and/or at most 60° with respect to the effective circle or a tangent to the circumference of the effective circle. In particular, in the case of the—preferably all of the—paddle wheels, only a uniform direction of rotation and/or one direction of rotation is provided, preferably counter to the conveyor-belt direction, that is to say counterclockwise. Underlaid means that, in plan view, the one or more series of rollers is completely enclosed by the series of paddle wheels.

A series of paddle wheels with paddle wheels adjacent one another, with pockets comprising V-shaped paddles oriented in the direction of rotation that underlie the one or more series of rollers allows a particularly high proportion of transversely oriented stalk half shells to be achieved in a panel. This is so because the falling-down stalk half shells are taken up by the rotating V-shaped paddles and moved by the centrifugal force into the transverse pockets that extend transversely. An adaptation of the orientation of the stalk half shells into the alignment of the transverse pockets in the transverse direction with respect to the conveyor-belt direction thereby takes place automatically. The direct adjacency of the paddle wheels to one another allows the effect be achieved that the stalk half shells are generally transported within the transverse pockets from the upper side of the series of paddle wheels downward onto the conveyor belt. Only a small part is squeezed through the closing gap between two effective circles of neighboring paddle wheels. Rather, long stalk half shells with longitudinal orientation particularly remain initially on the series of paddle wheels and move arbitrarily, until a changed orientation makes it possible for them to be taken up by the paddle wheels. The series of paddle wheels not only provides a transverse alignment of the stalk half shells, but also contributes to a homogeneous distribution of the stalk half shells on the conveyor belt over the length of the series of paddle wheels, in that regions with increased density of accumulation of the stalk half shells can be evened out over the length of the series of paddle wheels by the rotating paddle wheels.

With preference, in the case of the process a surface of the—in particular unworked—panel is removed and/or coated. Therefore, a coating of the—in particular unworked—panel to achieve a particularly low production expenditure is possible, or a coating after removal of at least one of the two surfaces of the panel to achieve a particularly high-quality surface is possible. Preferably, precisely both of the opposite planar surfaces are removed and/or coated.

In particular, at most 2 mm are removed. Removal may advantageously be performed by sanding or grinding to achieve great accuracy and production efficiency. Removal may also be performed by planning or peeling to achieve little and smooth removal. Removal may advantageously be performed by sand blasting to achieve a matt surface. Removal may advantageously be performed by stamping or pressing to achieve a smooth, impermeable surface. Removal may advantageously be performed by chemical processes or etching to achieve a structured surface.

A coating may advantageously be produced by painting with or applying a fire-retardant agent or a fire-retardant paint to achieve a very resistant layer and to eliminate an additional coloring step. A coating may likewise be advantageously produced by applying a single- or multi-layered UV (ultraviolet) vulcanizing and/or UV curing coating (ultraviolet curable coating) to achieve a particularly thin, resistant and water-repellent layer. For example, the UV coating agent from the company Treffert Coatings GmbH may be used for this purpose. Preferably, printing with color pigments may first be performed to avoid the effects of glare and then application of or printing with the UV coating agent may be performed in order to protect the color pigments particularly effectively from ambient influences.

A coating may also be advantageously produced by applying a film or cast film to achieve a particularly thin and impermeable coating, preferably of polypropylene (PP), for example from the company Daikin PPA. A coating may be advantageously produced by applying at least one phenolic resin paper (phenolic paper), that is to say a paper provided with phenolic resin, or hard paper, such as for example for advantageous use for concrete shuttering.

A coating may be advantageously performed by applying a top layer of veneer, MDF or thin particle board with the structure of a block board for producing a straw-based block board with the advantages described at the beginning. A coating may be advantageously performed by applying a veneer of a cork layer, an MDF board or a laminate. A coating may also be performed by means for producing a mold plate for cast parts (mold plate finish).

A coating may be advantageously performed by applying a veneer, a laminate and an in particular transparent overlay or cladding layer, preferably in the sequence stated. A particularly robust and high-quality panel can thus be produced.

A coating may advantageously be performed by applying at least one melamine paper (melamine-faced lamination paper), in particular on both surfaces, and on top an—in particular transparent—overlay or cladding layer, preferably in precisely the sequence stated. A particularly robust and high-quality panel, known as a “melamine faced panel”, can be thus produced.

With preference, in the case of the process only one or at least one, preferably two, with particular preference three, layers of kraft paper are applied to directly one or both untreated surfaces of the unworked panel and are bonded to the surface by hot pressing, in particular at temperatures of at least 100° C., with preference 150° C., with particular preference 180° C. and/or at most up to 250° C., with preference 220° C.

The surface of a panel means a planar side of a panel that extends parallel to the conveyor belt in the stadium of a mat of scattered material. The surface therefore does not mean the side edges.

Bonding a kraft paper to a directly untreated surface of the unworked panel has the effect of making it possible to provide a further-processed panel that has a particularly low susceptibility to deformations, for use as a floor covering for example—by doing away with an otherwise necessary intermediate layer—with particularly little production expenditure.

Preferred is kraft paper, a high-strength paper based on cellulose fibers, in particular with a weight of at least 80 g/m², with preference 100 g/m², with particular preference 110 g/m², and/or at most 150 g/m², with preference 140 g/m², with particular preference 130 g/m² or precisely 120 g/m². Preferred is kraft paper, in particular melamine-impregnated and/or phenolic-resin-impregnated, in order to make reliable bonding possible by hot pressing, in particular at temperatures of 100° C. to 250° C. In particular, the kraft paper can be printed with color pigments or has been printed with color pigments, in order to avoid effects of glare by improved light absorption.

With preference, in the case of the process one or both surfaces of the unworked panel is/are sanded by in each case at least 0.1 mm, with preference 0.4 mm, with particular preference 0.8 mm, and/or at most 2 mm, with preference 1.5 mm, with particular preference 1 mm, and only one or at least one, preferably two, with particular preference three, layers of kraft paper is/are applied directly to a sanded surface and bonded to the surface by hot pressing, in particular at temperatures of 100° C. to 250° C.

Grinding or sanded means in particular a working process for smoothing a surface of wood fibers or cereal crop fibers (sanding), a paper or a fabric generally serving as a carrier of abrasive material such as abrasive particles.

An only slightly sanded surface that can be provided with a kraft paper directly after the sanding has the effect of making it possible to provide a further-processed panel that has a particularly low susceptibility to deformations, for use as a floor covering for example—by doing away with an otherwise necessary intermediate layer—with particularly little production expenditure.

A further aspect of the disclosure concerns the use of the scattering head for scattering straw and/or reed onto a conveyor belt for producing a panel, in particular a panel with exclusively straw and/or reed as the fiber material and/or for mechanically load-bearing purposes within the scope of the area of use of OSB/1, OSB/2, OSB/3, P3, P5 and/or P7 boards.

A further aspect of the disclosure concerns a process for producing a panel, wherein first stalks of one or more cereal crops, such as straw and/or reed, are preferably shortened and for the greatest part, or to a proportion of over 80%, split in the longitudinal direction of the stalk in order to obtain elongate, approximately half-shell-shaped stalk half shells, which are then provided with binder and scattered by an outer-layer scattering head onto a conveyor belt running in the conveyor-belt direction, in order to accumulate there a mat of scattered material or a layer of a mat of scattered material of the stalk half shells, which is subsequently pressed under the effect of heat in order to obtain an unworked panel for use as a construction board or to produce a further-processed panel, for example for use as a floor covering or for the production of furniture, wherein the stalk half shells are fed through a material inflow unit of the outer-layer scattering head from above centrally onto a pyramid-shaped arrangement of a number of series of spindles arranged one above the other, the spindles respectively comprising a shaft transversely in relation to the longitudinal direction of the conveyor belt, on which a large number of disks are firmly attached coaxially in relation to the shaft and at a distance from one another, wherein the stalk half shells are transported by way of the rotating disks on an upper side of a series of spindles in a common unitary spindle-conveying direction parallel to the conveyor belt and a vertical passage opening area for allowing part of the stalk half shells to pass through opens downward between the disks of two neighboring spindles, at least in the case of some pairs of two neighboring spindles the disks overlapping one another and engaging in one another to reduce the vertical passage opening area, wherein all of the spindles of the outer-layer scattering head under the material inflow unit rotate in only a single, common unitary spindle-rotating direction, in order to move the stalk half shells—or rather the stalk half shells that have not been transported downward through the vertical passage opening area between two spindles but have remained on the upper side of the series of spindles—in only a single, common unitary spindle-conveying direction, only a throwback spindle at the end of a series of spindles being able to deviate from the unitary spindle-rotating direction for transporting back stalk half shells that otherwise fall down on the outside—that is to say beyond the outer end of the series.

A further aspect of the disclosure concerns an outer-layer scattering head—in particular for carrying out the process last described—for scattering elongate stalk half shells from a cereal crop onto a conveyor belt for producing a panel, with a material inflow unit and at least one series of spindles arranged one behind the other, a number of series of spindles being arranged one above the other in the form of a pyramid and centrally under the material inflow unit and only a single, common unitary spindle-rotating direction of all the spindles of the outer-layer scattering head being provided.

The pyramid-shaped arrangement of a number of series of spindles arranged one above the other centrally under the material inflow unit with only one unitary spindle-rotating direction of all the spindles, in particular for transporting the stalk half shells in only one unitary spindle-conveying direction, allows panels with different length gradients of the stalk half shells over the cross section of an outer layer to be produced particularly flexibly and with little production expenditure with the same outer-layer scattering head.

In particular, the outer-layer scattering head is an outer-layer scattering head for scattering elongate, approximately half-shell-shaped stalk half shells provided with binder onto a conveyor belt running in the conveyor-belt direction for producing an unworked panel for use as a construction board or a further-processed panel, for example for use as a floor covering or for the production of furniture, wherein stalks of one or more cereal crops, such as straw and/or reed, are preferably shortened and for the greatest part, or to a proportion of over 80%, split in the longitudinal direction of the stalk to produce the stalk half shells, characterized by a material inflow unit and a pyramid-shaped arrangement of a number of series of spindles arranged one above the other that are designed such that the stalk half shells can be transported by way of rotating disks on an upper side of a series of spindles in a common unitary spindle-conveying direction parallel to the conveyor belt and a vertical passage opening area for allowing part of the stalk half shells to pass through opens downward between the disks of two neighboring spindles, at least in the case of some pairs of two neighboring spindles the disks overlapping one another and engaging in one another to reduce the vertical passage opening area, only a single, common unitary spindle-rotating direction of all the spindles of the outer-layer scattering head being provided under the material inflow unit in order to move the stalk half shells in only a single, common unitary spindle-conveying direction.

The unitary spindle-rotating direction means that only in the case of a throwback spindle at the end of a series of spindles for transporting back stalk half shells that otherwise fall down to the side can a direction of rotation that deviates from the unitary spindle-rotating direction be provided. Otherwise, all of the spindles under the material inflow unit that are provided for conveying stalk half shells are subject to the unitary spindle-rotating direction.

The pyramid-shaped arrangement of a number of series of spindles arranged one above the other means in principle that all of the series of spindles are set up mirror-symmetrically in relation to a middle plane of the pyramid-shaped arrangement and the length of the series of spindles in the longitudinal direction parallel to the conveyor belt increases from top to bottom, so that a series of spindles is always underlaid by the series of spindles arranged directly thereunder. Feeding from above centrally onto a pyramid-shaped arrangement means that the stalk half shells are transported or fall centrally in the longitudinal direction, that is to say approximately centered in relation to the middle plane, onto the uppermost series of spindles. In particular, the extent of the material inflow unit in the longitudinal direction is therefore smaller than the uppermost series of spindles.

In the case of a pyramid-shaped arrangement of a number of series of spindles arranged one above the other, a person skilled in the art would not provide a unitary spindle-rotating direction of all the spindles for transporting the stalk half shells in only one unitary spindle-conveying direction, because as a result only half of the pyramid-shaped arrangement or only half of the spindles comes into contact at all with stalk half shells and remains unused.

However, this aspect of the disclosure is based on the idea that the additional investment and maintenance expenditure for providing twice the number of spindles as actually necessary for scattering and distributing the stalk half shells onto the conveyor belt—because half of the spindles do not come into contact with the stalk half shells at all—can be more than compensated by the savings that can arise as a result of the fact that this arrangement can create the possibility of dispensing with a laborious conversion when changing over production to a different type of panel with an outer layer of different characteristics.

Arranging the spindles symmetrically in the longitudinal direction makes it possible that, even with a reversal of the unitary spindle-rotating direction, different types of panel can be produced with the same outer-layer scattering head. It is also possible to avoid that, with different directions of rotation of spindles, the stalk half shells fall onto the conveyor belt on only a very small longitudinal region and with no or only very little orientation.

It is preferred in the case of the process and/or the outer-layer scattering head that the outer-layer scattering head comprises a controller for reversing the unitary spindle-rotating direction, in order to reverse the common unitary spindle-conveying direction into the opposite direction. The conveyor belt can move exclusively in only one conveyor-belt direction. A reversal of the direction of movement of the conveyor belt is not possible or not envisaged. With a reversal of the unitary spindle-rotating direction—which can generally be activated or set to a certain extent by the user pressing a button on the controller—all of the spindles of the outer-layer scattering head under the material inflow unit—including a throwback spindle—rotate in precisely the opposite direction of rotation.

By providing a controller for just reversing the unitary spindle-rotating direction, it is made possible for the controller and the outer-layer scattering head to be of a particularly simple construction and particularly easy to operate. The switching over of the unitary spindle-rotating direction, and consequently the unitary spindle-conveying direction, makes it possible that at least two different types of panel can be produced with the same outer-layer scattering head without a reconstruction or a laborious conversion of the outer-layer scattering head or the entire production plant, the various types of panel having different product properties, such as for instance surface characteristics, length distribution of the stalk half shells over the cross section as well as mechanical and physical properties. It is also made possible by arranging a scattering head and a further outer-layer scattering head along the same conveyor belt that a still greater number of different types of panel can be produced, the outer scattering head then producing just part of the mat of scattered material or a layer of stalk half shells of the mat of scattered material, and consequently of the later panel.

In particular, the process and the outer-layer scattering head provides only two unitary spindle-rotating directions for all of the spindles of the outer-layer scattering head—generally with the exception of the throwback spindle—, i.e. all of the spindles can rotate either only in the same one unitary spindle-rotating direction or in an opposite unitary spindle-rotating direction.

It is preferred in the case of the process and/or the outer-layer scattering head that the disks or some of the disks are produced from a nonferrous material, such as aluminum or plastic. The production costs for the outer-layer scattering head can thus be reduced and the weight of the outer-layer scattering head can be halved or at least significantly reduced. This in turn makes it possible to arrange more series of spindles and or more spindles per series without the provision of a stronger dimensioned, and consequently more expensive, supporting structure and suspension of the outer-layer scattering head. Furthermore, with very long stalk half shells in the length range of up to 150 mm and above, particularly low maintenance expenditure can be achieved by the use of disks of a nonferrous material.

It is preferred in the case of the process and/or the outer-layer scattering head that the spindles are arranged in at least two or precisely three substantially horizontal series one above the other.

At least two or precisely three series of spindles arranged substantially horizontally and one above the other allow the stalk half shells to be distributed onto the conveyor belt over a particularly great longitudinal region with particularly differentiated length distribution and orientation of the stalk half shells over the longitudinal region. This applies in particular to very long stalk half shells in the length range of up to 120 mm and above.

It is preferred in the case of the process and/or the outer-layer scattering head that, in a plane of spindles, all of the spindles are arranged directly adjacent or overlapping one another. A plane of spindles means a height plane approximately parallel to the conveyor belt. Therefore, there are not for example two series of spindles provided at a distance from one another in the same plane, but always only one series of spindles per plane. This allows a particularly efficient distribution to be made possible.

It is preferred in the case of the process and/or the outer-layer scattering head that the number of spindles of the uppermost series or of all of the series are uneven.

An uneven number of spindles in a series can bring about the effect that, with a reversal of the unitary spindle-rotating direction, when they meet the spindle the stalk half shells are deflected particularly efficiently to one side respectively in the longitudinal direction, in order to be oriented and distributed by the spindles arranged in this direction.

It is preferred in the case of the process and/or the outer-layer scattering head that finger-shaped disks are provided in an uppermost series of spindles and/or planar disks are provided in a lower series or the other series.

Finger-shaped disks in the uppermost series allow the usually interconnected stalk half shells to be loosened particularly effectively, distributed in the transverse direction, already oriented approximately in the longitudinal direction, turned over and distributed onto a series of spindles arranged thereunder over a particularly great longitudinal region. This applies in particular to very long stalk half shells in the length range of up to 120 mm and above.

Planar disks in one or more lower series allow an orientation of the stalk half shells in the longitudinal direction to be made possible particularly easily both with short stalk half shells and with very long stalk half shells.

Optionally, recesses, in particular grooves, may be incorporated on the circumference of a planar disk, or polygonal, in particular hexagonal or octagonal, disks may be used. Such forms of disk allow stalk half shells to be transported particularly effectively in the unitary spindle-conveying direction and distributed over a particularly great longitudinal region.

Optionally, an additional throwback spindle may be arranged at one end of a series of spindles, preferably in the upward direction and/or overlapping with the series of spindles, the throwback spindle also being able to overlap with one or two spindles in the longitudinal direction in plan view, for example in that the throwback spindle is arranged above or overlapping between the last and last-but-one spindle of a series.

It can be avoided by the throwback spindle that stalk half shells at the end of a series of spindles in the unitary spindle-conveying direction simply fall onto the conveyor belt, that is to say as accumulations of interconnected stalk half shells, and thereby cause inhomogeneities in the mat of scattered material that lead to a large density distribution in the later panel. By rotation—as an exception—counter to the unitary spindle-rotating direction, the throwback spindle to a certain extent throws the stalk half shells arriving at the end of the series of spindles back to the spindles, where the thrown-back stalk half shells are then distributed in the customary way in a downward direction through the vertical passage area.

It is preferred in the case of the process and/or the outer-layer scattering head that the spindles of the outer-layer scattering head have at least two different disk spacings along the shaft.

The provision of different disk spacings, and consequently different gap widths between the overlapping disks of two neighboring spindles, allows a length distribution of the stalk half shells over the longitudinal region to be specifically influenced and moreover larger, undesired foreign bodies to be rejected. This makes it possible to do without a separate upstream operation for screening or filtering the stalk half shells according to particle lengths to achieve a specific length distribution over the longitudinal region, and consequently over the cross section of the mat. It is similarly possible to dispense with a separate upstream step of rejecting oversized particles. Finally, the provision of at least two different disk spacings means that disks that are for the greatest part of the same construction can be used instead of differently shaped disks to achieve the same effects, and consequently an outer-layer scattering head can be provided with particularly little production expenditure.

It is preferred in the case of the process and/or the outer-layer scattering head that a small disk spacing is provided in the case of centrally arranged spindles, that is to say in a region of spindles that is arranged centered around the middle plane, and/or the number of such central spindles with a smaller disk spacing increases from the uppermost series of spindles to the lowermost series of spindles, that is to say the central spindles with a smaller disk spacing form a pyramid-shaped arrangement.

The provision of a small disk spacing in the case of centrally arranged spindles and/or a pyramid-shaped arrangement of such central spindles with a smaller disk spacing makes it particularly easily possible to provide a screening effect, in which short stalk half shells tend to or for the greatest part fall centrally onto the conveyor belt and long stalk half shells tend to or for the greatest part fall onto the outside of the conveyor belt at the outer-layer scattering head.

The stalk half shells are fed through the material inflow unit from above centrally onto the uppermost series of spindles, where in particular finger-shaped disks provide separation of interconnected loose accumulations of stalk half shells similar to hay bales and at the same time, by rotation in the unitary spindle-rotating direction, transport these in the unitary spindle-conveying direction, particularly short stalk half shells falling through the finger-shaped disks downward onto the series of spindles lying thereunder. In this second series of spindles, the centrally arranged spindles with a small disk spacing provide a build-up and further transportation also of short stalk half shells in the unitary spindle-conveying direction by rotation in the unitary spindle-rotating direction. Only a small part of the particularly short stalk half shells passes through the central spindles onto which they have fallen from above directly further downward in the direction of the conveyor belt. After meeting the series of spindles, most of the stalk half shells, and in particular the long ones, are initially transported in the direction of the unitary spindle-conveying direction, primarily short stalk half shells passing downward through the vertical passage area in the region of the central spindles with a small disk spacing and long stalk half shells only passing downward through the vertical passage area at outer spindles with a great disk spacing.

In this way, the loosely interconnected built-up stalk half shells transported onto the spindles through the material inflow unit are successively detached from one another, and distributed and scattered onto the conveyor belt over the entire half width of the outer-layer scattering head from the middle plane to the outermost end of a longest, lowermost series of spindles, the length of the stalk half shells that fall onto the conveyor belt continuously increasing from the middle to the outside, that is to say short stalk half shells being scattered onto the conveyor belt in the middle and long stalk half shells being scattered onto the conveyor belt at the outside.

Thus, with a counterclockwise unitary spindle-rotating direction, that is to say a unitary spindle-conveying direction counter to the running direction of the conveyor belt, initially long stalk half shells and then ever shorter stalk half shells are scattered by the constant movement of the conveyor belt in the conveyor-belt direction. A mat of scattered material and a later panel or a panel layer with a length gradient over the cross section from long stalk half shells at the bottom and ever shorter stalk half shells in the upward direction can thus be produced.

By analogy with this, with a reversal of the unitary spindle-rotating direction, that is to say a clockwise unitary spindle-rotating direction and a unitary spindle-conveying direction to the right in the conveyor-belt direction, initially short stalk half shells and then ever longer stalk half shells are scattered when there is constant movement of the conveyor belt—in always the same conveyor-belt direction to the right. A mat of scattered material and a later panel or a panel layer with a length gradient over the cross section from short stalk half shells at the bottom and ever longer stalk half shells in the upward direction can thus be produced.

Preferably, a series or all of the series of spindles consist(s) of spindles directly adjacent and/or overlapping one another. A particularly homogeneous distribution can thus be achieved.

In particular, in the one series at most five, with preference four, with particular preference three, centrally arranged spindles have a small disk spacing and/or in the series arranged thereunder preferably at least seven, with preference at least nine, with particular preference at least eleven, centrally arranged spindles have a small disk spacing.

In particular, the disk spacing in the case of centrally arranged spindles is at least 10 mm, with preference 15 mm, with particular preference 18 mm, and/or at most 30 mm, with preference 25 mm, with particular preference 22 mm.

In particular, a great disk spacing is provided in the case of spindles arranged on the outside, preferably a disk spacing of at least 30 mm, with preference 35 mm, with particular preference 40 mm, and/or at most 55 mm, with preference 50 mm, with particular preference 45 mm.

In particular, planar disks have a diameter of at least 200 mm, with preference 300 mm, with particular preference 350 mm, and/or at most 600 mm, with preference 500 mm, with particular preference 450 mm.

A further aspect of the disclosure concerns the use of the outer-layer scattering head for scattering straw and/or reed onto a conveyor belt for producing a panel, in particular a panel with exclusively straw and/or reed as the fiber material and/or for mechanically load-bearing purposes in particular within the scope of the area of use of OSB/1, OSB/2, OSB/3, OSB/4, P3, P5 and/or P7 boards.

A further aspect of the disclosure concerns a scattering head arrangement comprising an outer-layer scattering head according to the above description, a scattering head according to the above description and a further outer-layer scattering head of an identical construction, which are all arranged in a series and at a distance from one another over only one conveyor belt, which can move in only one conveyor-belt direction.

A particular advantage lies in the flexibility of the scattering head arrangement, which makes it possible to a certain extent at the press of a button to produce a panel with an entirely different layer structure and length gradient of the stalk half shells in the outer layers, it being possible for both short and long stalk half shells to be processed in the same scattering head arrangement without any appreciable conversion work. Consequently, a large number of different types of panel can be produced with the same scattering head arrangement particularly quickly and with particularly little production expenditure.

With preference, the unitary spindle-rotating direction of the one outer-layer scattering head is precisely the reverse of the unitary spindle-rotating direction of the further outer-layer scattering head. Thus, a panel with two surfaces of comparable characteristics can be produced.

With preference, a number of or precisely two scattering heads are arranged between two outer-layer scattering heads over the conveyor belt. A particularly easy variation of the panel thickness and also integration of other, inexpensive fillers, such as recycled scrap paper or recycled fiber material, can thus be incorporated in the panel particularly easily.

The object presented at the beginning is likewise achieved by a panel that can be produced or has been produced or has only been produced by the process according to the disclosure described above and/or the process according to a further aspect of the disclosure described above, in particular in combination with one or more of the preferred further developments of the process or the processes described above, the panel providing stalks of one or more cereal crops that are for the greatest part or to over 80% split into stalk half shells exclusively as the fiber material, the stalk half shells having a length of less than or equal to 4 mm to a proportion of at least 40%, with preference 50%, and/or at most 80%, with preference 60%.

A particularly smooth surface in comparison with wood-based OSB boards and also a particularly low density can thus be achieved, while achieving the same mechanical requirements in comparison with particle boards.

Preferably, the panel has a density of at least 400 kg/m3, with preference 500 kg/m³, with particular preference 570 kg/m³, and/or at most 950 kg/m³, with preference 800 kg/m³. As a result, the panel can be used for a large number of non-load-bearing and/or load-bearing application areas from furniture construction to floor coverings or as a construction board.

Preferably, the panel has a density distribution with a standard deviation of at most 20%, with preference 15%, with particular preference 10%, over the longitudinal extent of the panel, that is to say in the longitudinal direction of the panel. A panel with particularly few, minor defects, which can otherwise cause greater tool wear during further processing, unplanned deformations or ruptures under loading, be provided.

Fiber material means the basic material of generally vegetable, fiber-containing raw materials of the panel, which, while being substantially held together by binder, forms the later panel, that is to say for example wood chips in the case of OSB boards.

The panel according to the disclosure allows further processing with particularly little expenditure and can be used as an advantageous alternative to OSB panels or wood-based particle boards, because a further-processed panel has a particularly low susceptibility to deformation.

With preference, the panel may have a thickness of at least 3 mm, with preference 6 mm, with particular preference 8 mm, and/or at most 40 mm, with preference 25 mm. As a result, the panel can be used for a large number of application areas.

With preference, the panel has exclusively straw or reed as the fiber material, or a mixture of straw with a proportion of reed of at least 10%, with preference 15%, with particular preference 20%, and/or at most 40%, with preference at most 35%, with particular preference at most 30%.

A 100% straw panel, that is to say a panel with exclusively straw as the fiber material, can make a particularly high density and flexural rigidity possible.

A 100% reed panel, that is to say a panel with exclusively reed as the fiber material, can be realized with a particularly high density and mechanical strength values in the range of for example plywood boards. Thus, for example, a density of 800 kg/m³ or 950 kg/m³ can be produced. The lengths of the stalks are in this case longer by a multiple than in the case of HDF or HDP boards. A construction material board in the premium segment on the basis of a sustainable, natural, renewable vegetable raw material is thus made possible. Moreover, reed stalks allow a particularly high operating speed in the hot press and the panels produced have a comparatively high moisture content.

A mixed straw-reed panel, that is to say a panel with exclusively straw with a proportion of reed in the overall fiber material of the panel of at least 10% and/or at most 40%, can be provided with particularly high production efficiency and low production costs. In order to produce a particularly load-bearing construction material board with straw as the raw material, it is necessary to add a large amount of binder, which has a decisive influence on the expenditure involved in production. Moreover, isolated bubbles form during the hot pressing operation, and may lead to a high reject rate, which in turn can have an adverse influence on the expenditure involved in production and on strength. The formation of bubbles during the hot pressing operation can be effectively counteracted, or even avoided, by the addition of reed in the aforementioned proportions. A particularly low reject rate can thus be achieved. A high operating speed in the hot press made possible as result of the addition of reed provides a particularly high production efficiency and reduced production expenditure. If, for example, 25% reed is mixed with 75% straw and processed into a particularly load-bearing construction material board, the amount of rejects can be reduced by up to 20%, and at the same time up to 15% of binder can be saved, in comparison with an exclusively straw board, while the density and strength remain the same. Furthermore, the mixed straw-reed panel has a particularly high moisture content, which ensures that the board or the panel is not deformed in an undesirable way later, after installation, as a result of increased ambient atmospheric humidity.

In one embodiment, the panel with a thickness of 6 to 10 mm has a bending strength in the major axis according to EN 310 of at least 20 N/mm², 22 N/mm² or 30 N/mm² and/or a bending strength in the minor axis according to EN 310 of at least 10 N/mm², 11 N/mm² or 16 N/mm² and/or a transverse tensile strength according to EN 319 of at least 0.3 N/mm², 0.34 N/mm² or 0.5 N/mm². In one embodiment, the panel with a thickness of 11 to 17 mm has a bending strength in the major axis of at least 18 N/mm², 20 N/mm² or 28 N/mm² and/or a bending strength in the minor axis of at least 9 N/mm², 10 N/mm² or 15 N/mm² and/or a transverse tensile strength of at least 0.28 N/mm², 0.32 N/mm² or 0.45 N/mm².

In one embodiment, the panel with a thickness of 18 to 25 mm has a bending strength in the major axis of at least 16 N/mm², 18 N/mm² or 26 N/mm² and/or a bending strength in the minor axis of at least 8 N/mm², 9 N/mm² or 14 N/mm² and/or a transverse tensile strength of at least 0.26 N/mm², 0.3 N/mm² or 0.4 N/mm².

In one embodiment, the panel with a thickness of 6 to 25 mm has a modulus of elasticity in the major axis according to EN 310 of at least 2500 N/mm², 3500 N/mm² or 4800 N/mm² and/or a modulus of elasticity in the minor axis according to EN 310 of at least 1200 N/mm², 1400 N/mm² or 1900 N/mm².

In one embodiment, the panel with a thickness of 6 to 25 mm has a modulus of elasticity in the major axis of at least 2500 N/mm², 3500 N/mm² or 4800 N/mm² and/or a modulus of elasticity in the minor axis of at least 1200 N/mm², 1400 N/mm² or 1900 N/mm².

The fact that the panel according to one of these four last-described embodiments can achieve one or all of the characteristic values of the bending strength, transverse tensile strength and/or the modulus of elasticity means that applications conforming to the OSB/1, OSB/2 and/or OSB/4 standard according to EN 300 (in the sequence of the values linked by “or”) are achieved, in particular with regard to the load-bearing capacity with at the same time a particularly low density and surface roughness, the requirements for OSB/2 and/or OSB/3 being the same here with respect to the bending strength, transverse tensile strength and the modulus of elasticity.

In one embodiment, the panel has a bending strength in the major axis after a cyclic test according to EN 321/310 of at least 9 N/mm² or 15 N/mm², a transverse tensile strength after a cyclic test according to EN 321/319 of at least 0.18 N/mm² or 0.21 N/mm², and/or a transverse tensile strength after a boil test according to EN 1087-1/EN 319 of at least 0.15 N/mm² or 0.17 N/mm². As a result, OSB/3 and/or OSB/4 standards can be achieved—in particular for thicknesses from 6 mm—in accordance with the sequence of the values linked by “or”, and resultant application areas can be covered, with at the same time a particularly low density and surface roughness.

In one embodiment, the panel has a bending strength of 10.5 N/mm², 15 N/mm², 18 N/mm² or 22 N/mm² and/or a transverse tensile strength of 0.28 N/mm², 0.45 N/mm², 0.45 N/mm² and/or 0.75 N/mm². As a result, P1, P3, P5 and/or P7 standards according to EN 312 can be achieved—in particular for thicknesses from 6 mm—in accordance with the sequence of the values linked by “or”, and resultant application areas can be covered, with at the same time a particularly low density and surface roughness.

In one embodiment, the panel has a modulus of elasticity of at least 2050 N/mm², 2550 N/mm² or 3350 N/mm²,

a transverse tensile strength after a cyclic test of at least 0.15 N/mm², 0.25 N/mm² or 0.41 N/mm² and/or a transverse tensile strength after a boil test of at least 0.09 N/mm², 0.15 N/mm² or 0.25 N/mm². As a result, P3, P5 and/or P7 standards can be achieved—in particular for thicknesses from 6 mm—in accordance with the sequence of the values linked by “or”, and resultant areas of use for products with corresponding approval requirements can be opened up, with at the same time a particularly low density and surface roughness.

In a preferred embodiment, the panel has a density of at least 520 kg/m³ or 650 kg/m³, and/or at most 950 kg/m³, with preference at most 720 kg/m³, for use for non-load-bearing applications, for example to comply with the OSB/1 standard, and/or load-bearing applications, for example to comply with the requirements according to OSB/2, OSB/3 and/or OSB/4 standards. For example, in the case of a panel at the lower density limit, the OSB/4 standard can likewise be met by a high proportion of binder. Particularly easy handling of a panel can thus be achieved, with at the same time a particularly low raw material requirement.

In a preferred embodiment, the panel has a density of at least 570 kg/m³ and/or at most 950 kg/m³, with preference at most 680 kg/m³, for use for non-load-bearing applications, for example to comply with the P1 standard, and/or load-bearing applications, for example to comply with the requirements according to the P3, P5 and/or P7 standard. For example, in the case of a panel at the lower density limit, the P7 standard can likewise be met by a high proportion of binder. Particularly easy handling of a panel can thus be achieved, with at the same time a particularly low raw material requirement.

In particular, the panel is designed such that the panel has a coating directly on a surface that is untreated or from which material has been removed. A panel on the basis of cereal crops as the raw material with a particularly high-value surface can in this way be provided while involving particularly little production expenditure.

In the case of the variant with a surface from which material has been removed, advantageously at most 2 mm is removed. A particularly smooth surface can thus be produced without particularly great expenditure. Removal may advantageously be performed by sanding or grinding to achieve great accuracy and production efficiency. Removal may also be performed by planning or peeling to achieve little and smooth removal or by sand blasting to achieve a matt surface. Removal may also be performed by stamping or pressing to achieve a smooth, impermeable surface or by chemical processes or etching to achieve a structured surface.

In a preferred embodiment, the panel has a surface roughness of a surface—in particular untreated or from which material has been removed directly after the hot pressing—of a mean roughness value Ra of at least 0.050 mm, with preference 0.075 mm, with particular preference 0.100 mm, and/or at most 0.400 mm, with preference 0.3000 mm, with particular preference 0.250 mm. The mean roughness value Ra corresponds to the arithmetic mean of the deviations from the center line. Direct application of a coating or a kraft paper to the surface that is untreated or from which material has been removed—in particular sanded—is thus made possible.

A coating may advantageously be produced by painting with or applying a fire-retardant agent or a fire-retardant paint to achieve a very resistant layer and to eliminate an additional coloring step.

A coating may be advantageously produced by applying a single- or multi-layered UV (ultraviolet) vulcanizing and/or UV curing coating (ultraviolet curable coating) to achieve a particularly thin, resistant and water-repellent layer. For example, the UV coating agent from the company Treffert Coatings GmbH may be used for this purpose. Preferably, printing with color pigments may first be performed to avoid the effects of glare and then application of or printing with the UV coating agent may be performed in order to protect the color pigments particularly effectively from ambient influences.

A coating may be advantageously produced by applying a film or cast film to achieve a particularly thin and impermeable coating, preferably of polypropylene (PP), for example from the company Daikin PPA. A coating may be advantageously produced by applying at least one phenolic resin paper (phenolic paper), that is to say a paper provided with phenolic resin, or hard paper, such as for example for advantageous use for concrete shuttering.

A coating may advantageously be a top layer of veneer, MDF or thin particle board with the structure of a block board for producing a straw-based block board with the advantages described at the beginning. A coating may be advantageously designed such that the panel with the coating can be used as a mold plate for cast parts (mold plate finish). A coating may advantageously be a veneer, a cork layer, an MDF board or a laminate. A coating may advantageously comprise a veneer, a laminate and an in particular transparent overlay or cladding layer, or consist thereof, or be constructed precisely in this sequence. A particularly robust and high-quality panel can thus be produced.

A coating may advantageously comprise at least one melamine paper (melamine-faced lamination paper), in particular on both surfaces, and on top an in particular transparent overlay or cladding layer, or consist thereof, or be constructed precisely in this sequence. A particularly robust and high-quality panel, known as a “melamine faced panel”, can be thus produced.

In a preferred embodiment, the panel has only one or at most three layers of kraft paper directly on a surface that is untreated or has been sanded after the hot pressing by at least 0.10 mm, with preference 0.15 mm, with particular preference 0.20 mm, and/or at most 0.35 mm, with preference 0.3 mm, with particular preference 0.25 mm. An intermediate layer for smoothing can thus be eliminated.

With preference, the panel comprises a surface with decoration produced by color pigments and/or a balancing layer, in particular of kraft paper or in the form of a layer of plastic. A panel with a surface with decoration produced by color pigments makes improved light absorption possible to avoid the effects of glare. A panel with a balancing layer of kraft paper or a film of plastic counteracts deforming of the panel under loading due to flexural forces occurring.

In one embodiment, the in particular unworked—that is to say untreated—panel comprises a middle layer between two outer layers, with in particular stalk half shells with a length of at most 150 mm, with preference at most 130 mm, with particular preference at most 110 mm, the middle layer and the outer layers being oriented parallel to the surface of the panel and/or the stalk half shells in the middle layer tending to or for the greatest part being transversely oriented and/or in the outer layers tending to or for the greatest part being longitudinally oriented.

In the case of one of the outer layers, stalk half shells with a length greater than 9.5 mm and less than 135 mm may make up a proportion of at least 30% of the surface of the panel, while there may also be length gradient of the stalk half shells from long stalk half shells at the surface to short stalk half shells at a boundary surface of the outer layer to the middle layer, and at the boundary surface stalk half shells with a length greater than 9.5 mm may make up a proportion of at most 30%.

In the case of one of the outer layers, stalk half shells with a length greater than 9.5 mm and less than 135 mm likewise make up a proportion of may at most 30% of the surface of the panel, while there only also may/be a length gradient of the stalk half shells from short stalk half shells at the surface to long stalk half shells at a boundary surface of the outer layer to the middle layer, and at the boundary surface stalk half shells with a length greater than 9.5 mm may make up a proportion of at least 30%.

With the length gradient, all of the lengths of stalk half shells in the ranges of less than 4 mm, 4 mm to 9.5 mm and 9.5 mm to 135 mm may be represented. This means that none of these length ranges is not covered by correspondingly long stalk half shells. Particularly good flexural rigidity can thus be obtained.

The “proportion of the surface” means the visible surface area of stalk half shells of the specified length ranges as a proportion of the overall surface. This “proportion of the surface” may be determined by way of optical measuring methods.

In particular, the panel comprises altogether a proportion, that is to say a proportion by weight, of stalk half shells of at least 3%, with preference 5%, with particular preference 8%, and/or at most 15%, with preference 13%, particularly 11%, with a length greater than 9.5 mm and/or at most 150 mm, preferably 130 mm, with particular preference 110 mm.

The outer layer and the middle layer mean a layer oriented parallel to the surface that can generally be assigned to a separate layer of the mat of scattered material that has been built up by a separate scattering head.

The boundary layer means the surface area at which the outer layer and the middle layer meet. In the case of a boundary layer, the “proportion of the surface” can only be determined by separating the layers at the boundary layer for the purpose of measurement, for example optical measurement.

A surface of the panel that has stalk half shells with a length greater than 9.5 mm to a proportion of 30% makes it possible to provide a panel that has a particularly high reflectance of light, which when used for interior design can contribute to brightening up a room. At the same time, the panel has in the cross section of the outer layer a length gradient of the stalk half shells from long stalk half shells at the surface to short stalk half shells at the transitional area to the middle layer. This can make a particularly high rupture resistance possible.

A boundary surface that has stalk half shells with a length greater than 9.5 mm to a proportion of 30%, that is to say may have only short stalk half shells on the surface of the same outer layer, makes possible a panel that has a particularly nonslip surface. At the same time, the panel has in the cross section of the outer layer a length gradient of the stalk half shells from short stalk half shells at the surface to long stalk half shells at the transitional area to the middle layer. This can make particularly high flexibility possible.

A further aspect of the disclosure concerns the use of the—in particular unworked—panel described on the previous pages that has been produced by the process described above, in particular in combination with the preferred further developments of the process described above, as a board for interior design, including furniture for use in the dry area or as a construction board for building and structural work.

A further aspect of the disclosure concerns the use of the—in particular further-processed—panel described on the previous pages that has been produced by the process described above, in particular in combination with the preferred further developments of the process described above, as a board for load-bearing purposes for use in the wet area or as a floor covering or a wall covering for interior design, in particular such that it can meet the mechanical requirements according to the standards OSB/1, OSB/2, OSB/3, OSB/4, P3, P5 and/or P7.

These and other features of the present disclosure will become more apparent from the following description of the illustrative embodiments.

### BRIEF DESCRIPTION OF THE DRAWINGS

The aspects of the disclosure are explained in more detail below on the basis of exemplary embodiments that are schematically represented by drawings and with reference to the drawings, which describe embodiments and also additional advantageous refinements more specifically and in which:

FIG. 1 shows a schematic representation of a scattering head;

FIG. 2 shows a schematic representation of a detail of a series of rollers;

FIG. 3 shows a schematic representation of a scattering head arrangement with a scattering head and an outer-layer scattering head;

FIG. 4 shows a schematic representation of a cross section through a panel produced with the scattering head;

FIG. 5 shows measuring curves of density profiles in the longitudinal direction;

FIG. 6 shows a schematic representation of a cross section through a panel with long stalk half shells on both surfaces; and

FIG. 7 shows a schematic representation of a cross section through a panel with short stalk half shells on both surfaces.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

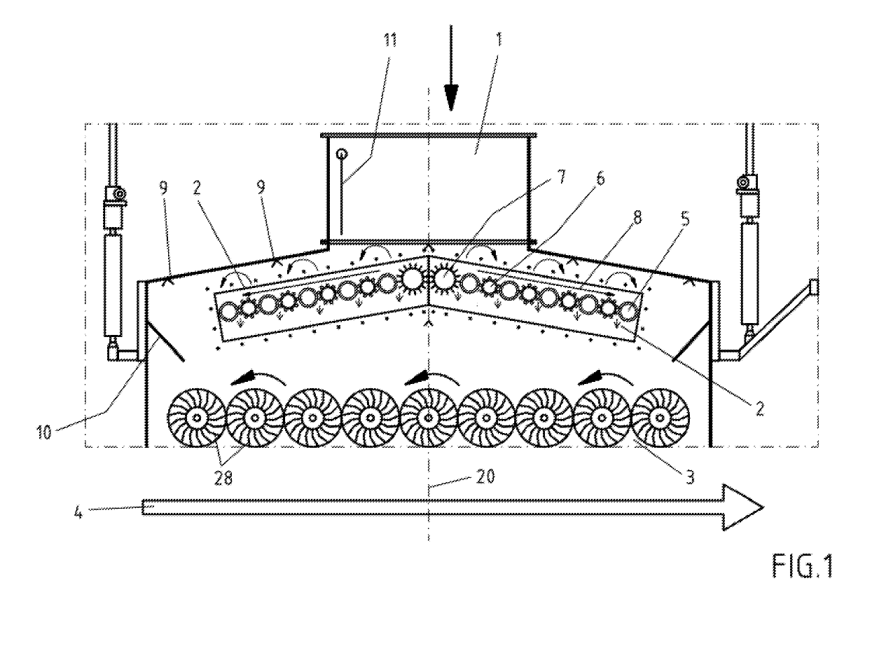

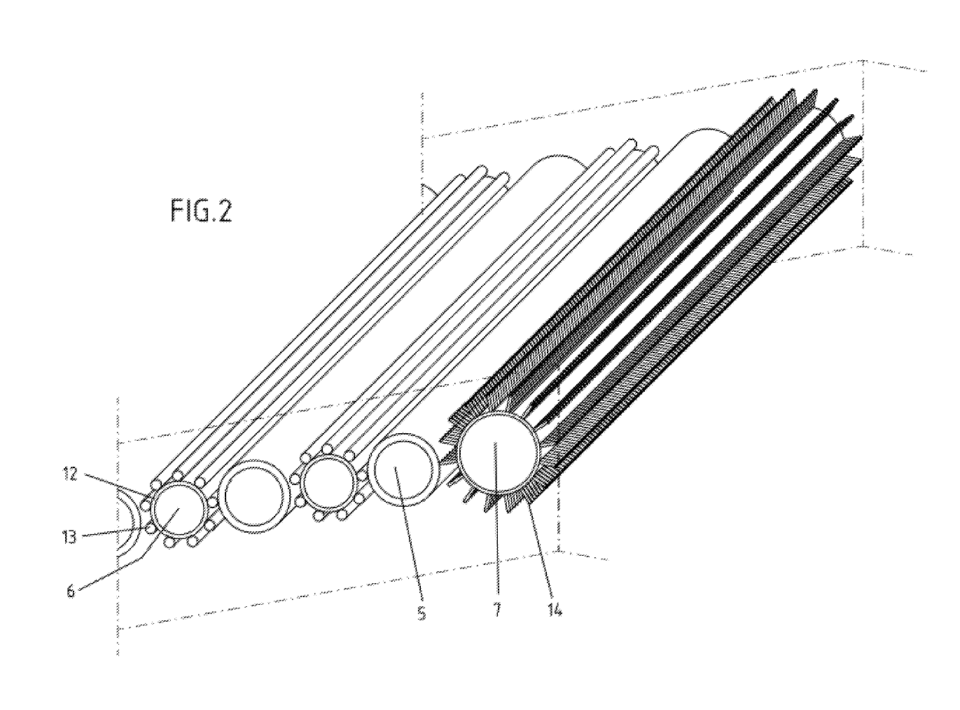

FIG. 1 shows a scattering head comprising a smooth roller 5 as a conveying roller with a rotationally symmetrical lateral surface and a planetary roller 6 as a conveying roller with a non-rotationally symmetrical lateral surface, a number of planetary cylinders 13 being arranged axially parallel as elevations on a lateral surface of a main cylinder 12. Stalk half shells in the form of loosely interconnected accumulations are fed by way of the material inflow unit 1 onto the porcupine rollers 7 as the first conveying roller respectively of two series of rollers 2 arranged mirror-symmetrically about a middle plane 20. Separation of the accumulations into stalk half shells that are separated as far as possible takes place by a large number of radial spikes 14 of the porcupine roller 7, which are arranged with high density on the lateral surface of the porcupine roller. FIG. 2 shows the exact construction of the conveying rollers 5, 6, 7 of the series of rollers 2. The rotating smooth roller 5 and a neighboring, directly adjacent, rotating planetary roller 6, with planetary cylinders 13 arranged around a main cylinder 12, form an opening and closing vertical passage, which in FIG. 2 is shown in the closed position. In the closed position, a planetary cylinder 13 and the smooth roller 5 is separated only by a narrow closing gap, which does not allow any appreciable amounts of stalk half shells to pass through downward.

Illustrativley, the conveying rollers 5, 6, 7, etc. alternately have a rotationally symmetrical lateral surface and a non-rotationally symmetrical lateral surface with depressions and/or elevations. As such, a first roller includes a rotationally symmetrical lateral surface, a second roller directly adjacent the first roller includes a non-rotationally symmetrical lateral surface with depressions and/or elevations, a third roller directly adjacent the second roller includes a rotationally symmetrical lateral surface, etc., as shown in FIGS. 1 and 2.

The rotation of the conveying rollers brings about the effect of an increasing distance between the planetary cylinder 13 that is moving away from the smooth roller 5, until the next planetary cylinder 13 approaches the smooth roller 5 and a vertical passage opening thus increasingly becomes smaller in size again.

Together with the width of the series of rollers on a plane that is defined by the conveying roller axes of the series of rollers, this distance forms the vertical passage opening.

The round form of the planetary cylinders 6 has the effect that long stalk half shells are pushed in the series-of-rollers conveying direction 8, without necessarily being drawn into the vertical passage opening between the smooth roller 5 and the planetary roller 6. Depending on the distance from the main cylinder 12 of the planetary roller 6, short stalk half shells in the buildup on the series of rollers 2 are either displaced laterally or obliquely upward by the planetary cylinders 13 or are pushed in the direction of the main roller 12, in order to be transported downward. As a result, only part of the built-up stalk half shells at a smaller distance from the main cylinder 12 are transported downward. The transverse orientation of the planetary cylinders at the same time brings about a first transverse orientation, in particular in the case of long stalk half shells, if they stray into the intermediate space between the planetary cylinder 13 and the main cylinder 12.

As a result of surface friction with a rotating smooth roller 5, short stalk half shells are entrained by the lateral surface of the smooth roller 5 and transported further. Long stalk half shells often undergo only a small advancing pulse from rotating smooth rollers because of the small surface bearing contact, and are entrained rather by the more or less interconnecting stream of stalk half shells that is to a certain extent pushed by the planetary rollers 6 in the series-of-rollers conveying direction 8 by the planetary cylinders 13.

By increasing or reducing the rotational speed of the conveying rollers 5, 6, 7 and/or the angle of inclination of the series of rollers 1, which generally a a scattering head unlike the rotational speed of the conveying rollers 5, 6, 7 cannot be variably set, the stream of stalk half shells can be set such that at the end of a series of rollers 2 virtually all the stalk half shells have been transported downward through vertical passage openings and on the outside at the end of a series of rollers 2 only a few isolated stalk half shells stray beyond the end and fall downward there. A distribution and scattering that is homogeneous over the series of rollers 2 can therefore be achieved. Those isolated stalk half shells that are transported beyond the outer end of the series of rollers 2 are in particular arranged by a throwback device 10, preferably a metal plate inclinded toward the middle, at a distance of at least one to three conveying roller diameters from the end of the series of rollers 2, which ensures that stalk half shells that fall down on the outside are fed in the direction of the middle to the series of paddle wheels 3 arranged under the series of rollers 2, in order to be distributed there. A panel with particularly low variation in density over the length can thus be produced.

In particular, deflecting devices 9, preferably in the form of roof-shaped metal plates—that is to say metal plates in the form of an inverted V—are provided, centered in relation to the middle plane 20 between the material inflow unit 1 and the porcupine rollers 7 and/or centered in relation to the middle plane 20 between the series of rollers 2 and the series of paddle wheels 3, in order to separate as centrally as possible the stalk half shells falling down from the material inflow unit 1 and distribute them as uniformly as possible onto both series of rollers 2 or the series of paddle wheels 3.

In particular, inside the material inflow unit 1 there is provided a guide flap 11, with which the stalk half shells flowing into the material inflow unit 1 can be deflected in such a way that the stream meets the deflecting device 9 between the material inflow unit 1 and the series of rollers 2 as centrally as possible and/or meets the porcupine rollers 7 of the two series of rollers 2 as far as possible in equal parts, in order to make a particularly uniform distribution of the stalk half shells between the two series of rollers 2 possible.

In particular, further deflecting devices 9 are provided on a housing wall above a series of rollers 2 and/or in the region of the beginning of a series of rollers 2 and/or in the region of the end of a series of rollers 2, in order to break up the stream of half stalk shells.

The series of paddle wheels 3 arranged under the series of rollers 2, with paddle wheels adjacent one another that preferably all rotate only in the same direction, provides improved orientation of the stalk half shells in the transverse direction. For this purpose, the paddle wheels have a large number of pockets, which are oriented with an open side in the direction of rotation. The pockets are formed by two V-shaped paddles in each case, which point at an acute angle to a lateral surface of a cylinder roller of the paddle wheel with the tip of the V shape counter to the direction of rotation. Particularly long stalk half shells can thus be effectively captured by the paddle wheels and, by being transported into the pockets, scattered in a transversely oriented manner downwardly onto the conveyor belt 4.

FIG. 4 shows a schematically represented cross section of a panel that has been produced by stalk half shells of straw and/or reed with a length of less than 4 mm to a proportion, that it to say a proportion by weight, of 80% exclusively being scattered through the scattering head—or in principle also a number of scattering heads, in particular of an identical construction, arranged next to one another over the conveyor belt 4—onto a conveyor belt 4 and built up there to form a mat of scattered material. An unworked panel with a layer of stalk half shells 22 has been produced by hot pressing the mat of scattered material.

The unworked panel has in particular a thickness of at least 11 mm and/or at most 17 mm, a bending strength in the major axis of at least 20 N/mm², a bending strength in the minor axis of at least 10 N/mm², a modulus of elasticity in the major axis of at least 3500 N/mm², a modulus of elasticity in the minor axis of at least 1400 N/mm², a transverse tensile strength of at least 0.7 N/mm², a bending strength in the major axis after a cyclic test of at least 8 N/mm², a transverse tensile strength after a cyclic test of at least 0.36 N/mm² and/or a transverse tensile strength after a boil test of at least 0.23 N/mm². The panel can consequently meet the mechanical requirements of the OSB/3 standard according to EN 300 and/or the P7 standard according to EN 312, thereby making possible approved areas of use that would not otherwise be accessible to a panel on the basis of crop cereals as the raw material.

Preferably, the panel also has a swelling thickness after 24 hours according to EN 317 of at most 10% and/or a swelling thickness after a cyclic test according to EN 321 of at most 11%. Consequently, the main remaining requirements of the OSB/3 standard according to EN 300 and of the P7 standard according to EN 312 can also be met and a particularly wide area of use can be opened up.

After the hot pressing, preferably only one layer of kraft paper 29 impregnated in melamine resin was applied by hot pressing to the layer of stalk half shells 22 as a coating, directly onto the untreated surface or the surface from which 0.2 mm has been removed, and/or before or after the hot pressing the kraft paper comprises a decoration produced by color pigments, in order for example to be able to be used as a floor covering.

FIG. 5 shows two exemplary measuring curves, which represent the density profile of the density 27 over the length 26 of two differently produced mats of scattered material. The scattering-head measuring curve 31 shows the density profile of a mat of scattered material that is based on an unworked panel, in particular the panel from FIG. 4, before the hot pressing. The density of the mat of scattered material at a measuring point in the longitudinal direction corresponds substantially to the density of the panel at the location or the measuring point after the hot pressing. The reference measuring curve 30 shows the density profile of a mat of scattered material that has been produced with a conventional scattering head according to the prior art without vertical passages, consisting of a smooth roller 5 and a planetary roller 6. As the comparison shows, the variation of the density can be significantly reduced by the scattering head according to the disclosure, and thus a panel with particularly few, minor defects, which can otherwise cause greater tool wear during further processing, unplanned deformations or ruptures under loading, can be provided.

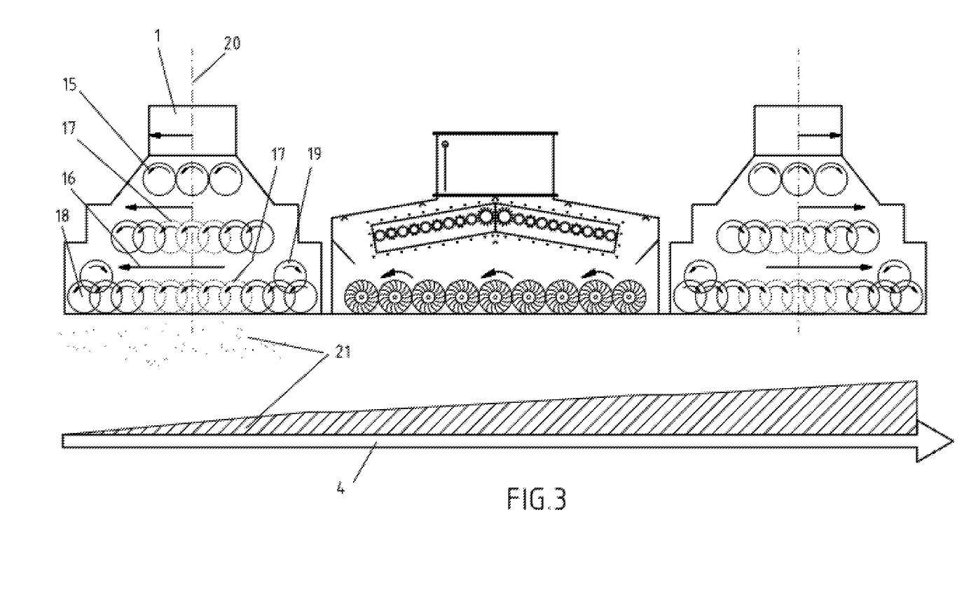

FIG. 3 shows a schematic scattering head arrangement with two outer-layer scattering heads of an identical construction and a scattering head arranged in between that corresponds to the scattering head from FIG. 1. The entire scattering head arrangement is arranged over only one conveyor belt 4, in order to produce a multi-layered mat of scattered material on the conveyor belt 4. The conveyor belt 4 runs only in one conveyor-belt direction (to the right in FIG. 3).

The schematically represented outer-layer scattering heads both have three series of spindles 17, 18 arranged one behind the other, the series of spindles 17, 18 being arranged one above the other in the form of a pyramid and centrally under the material inflow unit 1, and in the case of both outer-layer scattering heads only a single, common unitary spindle-rotating direction 15 of all the spindles 17, 18 of the outer-layer scattering head being respectively provided for transporting the stalk half shells that have not already fallen downward between two spindles 17, 18 in only one unitary spindle-conveying direction 16.

The first outer-layer scattering head on the side of the scattering head in the opposite conveyor-belt direction (the left-hand scattering head in FIG. 3) provides a unitary spindle-rotating direction 15 counter to the conveyor-belt direction, that is to say counterclockwise. On the path in the unitary spindle-conveying direction 16 above the series of spindles 17, 18, initially small stalk half shells fall through the centrally arranged spindles 18 with a small disk spacing and after that—particularly in the region of the spindles 18 with great disk spacings—increasingly long stalk half shells fall downward. As a result of the constant movement of the conveyor belt 4 in the conveyor-belt direction, first long stalk half shells are thus scattered onto the conveyor belt 4. Then, with the movement of the conveyor belt 4 in the conveyor-belt direction, ever shorter stalk half shells fall onto the long stalk half shells, so that in this first outer layer of the mat of scattered material—and consequently of the later unworked panel—there is created a length gradient from long stalk half shells at the surface or at the bottom to ever shorter stalk half shells in the upward direction over the cross section. In particular, the first outer-layer scattering head is also fed stalk half shells that have a proportion with a length between 9.5 mm to 130 mm of altogether 10% and to a proportion with a length less than 4 mm of altogether 40%.

Stalk half shells that tend to be transversely oriented and have a length of less than 4 mm to a proportion of altogether 80% are piled up by the scattering head on this first outer layer of the mat of scattered material, and thus a middle layer without a length gradient over the cross section is produced. The length distribution of the stalk half shells that are fed to the scattering head may thus deviate from the length distribution of the stalk half shells for one or both outer-layer scattering heads.

The second outer-layer scattering head, on the side of the scattering head in the conveyor-belt direction (the right-hand scattering head in FIG. 3), provides a unitary spindle-rotating direction 15—reversed in comparison with the first outer-layer scattering head, that is to say precisely opposite—in the conveyor-belt direction, that is to say clockwise. On the path in the unitary spindle-conveying direction 16 above the series of spindles 17, 18, initially for the greatest part small stalk half shells and after that more and more long stalk half shells fall downward. This length-dependent distribution is promoted by the pyramid-shaped arrangement of the middle spindles 17. As a result of the constant movement of the conveyor belt in the conveyor-belt direction, first short stalk half shells are thus scattered onto the middle layer of the mat of scattered material on the conveyor belt. Then, with the movement of the conveyor belt 4 in the conveyor-belt direction, ever longer stalk half shells fall onto the short stalk half shells, so that in this second outer layer of the mat of scattered material—and consequently of the later unworked panel—there is created a length gradient from long stalk half shells at the surface to ever shorter stalk half shells in the direction of the middle layer over the cross section. In particular, the first outer-layer scattering head is also fed stalk half shells that have a proportion with a length between 9.5 mm to 130 mm of altogether 10% and to a proportion with a length less than 4 mm of altogether 40%.

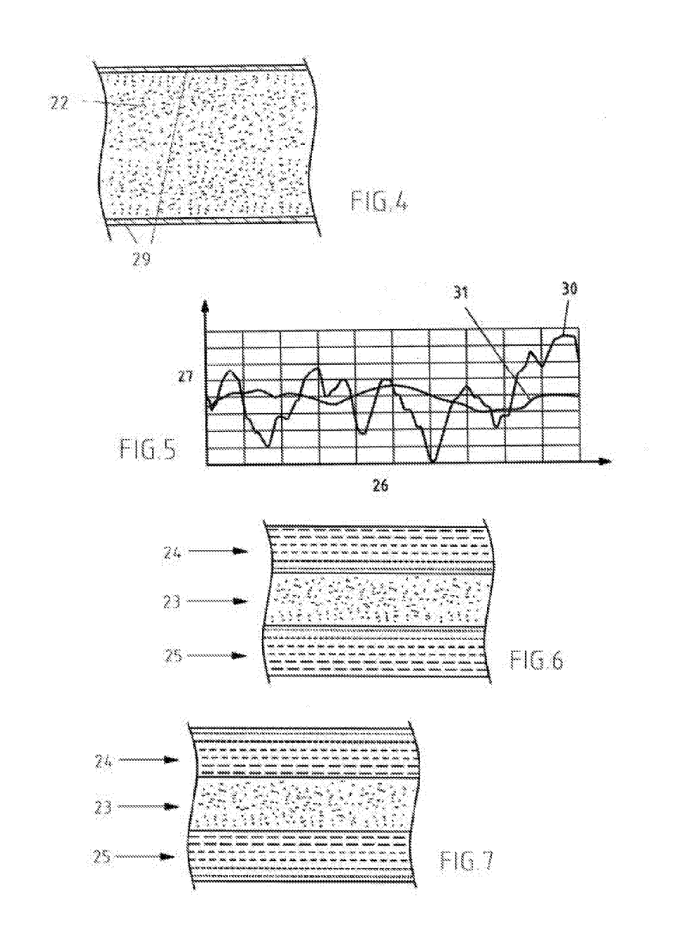

After the hot pressing, the panel thus produced has a cross section that is schematically represented in FIG. 6.

FIG. 7 shows another type of panel, which can be produced by the unitary directions of rotation 15 that are described above of the outer-layer scattering heads as represented in FIG. 3 being respectively reversed. Short stalk half shells can then be found on both surfaces and long stalk half shells in the direction of or at the boundary layer with respect to the middle layer.

Particularly, the material inflow unit 1 is configured such that the guide flap 11 can be pivoted in direction of the middle plane 20, preferably about a pivot axis that runs crosswise to the conveyor-belt direction. The pivot axis is preferably arranged at one side of the material inflow unit 1 in or against the conveyor-belt direction and preferably in an upper area of the material inflow unit 1 such that the guide flap 11 can be pivoted in direction of the middle plane 20 and thereby can deflect the from above and usually from one side in or against the conveyor-belt direction falling down material to the middle plane 20. For that purpose, the guide flap 11 has basically a rectangular shape, which preferably has a width crosswise to the conveyor-belt direction and/or an length oriented orthogonal to the width, wherein the length and width are by many times larger than the thickness.

Preferred are fixation means for fixating the guide flap 11 in a pivoted position, so that the guide flap 11 does not need to be hold manually in the pivoted position, wherein a preferred pivoted position has an angle of preferably at least 30 degree and/or at most 60 degree, preferred 45 degree, relative to a vertical.

The guide flap 11 has a radial edge, which is arranged at the opposite side of the pivot axis and extents in direction of the width of the guide flap 11. The pivot axis and the length of the guide flap 11 are configured such that the radial edge crosses the middle plane 20 during pivoting from 30 degree to 60 degree and/or at about 45 degree (±10 degree) the radial edge is adjacent to the middle plane 20. The stream can thereby be distributed equally in conveyor-belt direction with little effort.

Particularly, the guide flap 11 has at least one cut out, thus a recess, and/or at most ten cut outs. Material that mostly or entirely falls down sidewise the middle plane 20 from above onto the guide flap 11 is thereby reaching partly already throught the cut out or cut outs to the opposed side of the direction of deflection. Preferably, the area, number or total summed up areas of the cut out or cut outs are so large that at least 30% and/or at most 50% of the material falling onto the guiding flap 11 is passing the cut out or cut outs. A particularly uniform distribution of the stalk half shells between the two series of rollers 2 is thus possible.

Particularly, the cut out flushs with the radial edge and form a U-shape in the edge contour, which is preferably rectangular shaped. More cut outs can form a particularly uniform pattern with more than one U-shaped cut outs with particularly same width, wherein preferably the U-shaped cut outs have in direction of the width a distance between one and the next neighboring one corresponding to the width of the U-shape. The width of a cut out preferably correspond at least three times the length and/or at most ten times the length of the guide flap 11. The length of the cut out is preferably larger than one tenth of the length of the guide flap 11 and/or smaller than half of the length of the guide flap 11.

The above described cut out or cut outs enable a particularly equal distribution of the stalk half shells over the width.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A process for producing a panel,
wherein first stalks of one or more cereal crops are for the greatest part split in the longitudinal direction of the stalk in order to obtain elongate, approximately half-shell-shaped stalk half shells,
which are then provided with binder and scattered by a scattering head onto a conveyor belt running in the conveyor-belt direction, in order to build up there a mat of scattered material or a layer of a mat of scattered material of the stalk half shells,
which is subsequently pressed under the effect of heat in order to obtain an unworked panel for use as a construction board or to produce a further-processed panel,
wherein the stalk half shells are fed through a material inflow unit of the scattering head from above onto an upper side of a series of rollers with conveying rollers of the scattering head arranged one behind the other in a series-of-rollers conveying direction and transported from there along the upper side of the series of rollers directly on the rotating conveying rollers in the series-of-rollers conveying direction,
part of the stalk half shells in each case passing through the series of rollers downward in the direction of the conveyor belt during the transportation along the upper side of the series of rollers, through a number of vertical passages distributed in the series-of-rollers conveying direction, each vertical passage periodically opening and closing, and
wherein a substantially rectangular vertical passage opening that continuously increases in size, decreases in size and closes, in order to transport only part of the stalk half shells downward through the series of rollers, is provided over an entire width of the series of rollers.

2. The process of claim 1, wherein the periodically opening and closing vertical passage comprises two conveying rollers directly adjacent one another, one conveying roller being a smooth roller with the form of a cylinder with a smooth lateral surface and the other conveying roller being a planetary roller, the planetary roller comprising a main cylinder with the form of a cylinder with a smooth lateral surface and also at least two cylindrical planetary cylinders, which are aligned parallel to the main cylinder and have the same outside diameter, the planetary cylinders having a smaller outside diameter than the main cylinder and being firmly connected to the lateral surface of the main cylinder.

3. The process of claim 2, wherein the planetary roller comprises at least four and at most fourteen planetary cylinders and the planetary cylinders are arranged distributed at equal distances over the circumference of the main cylinder of the planetary roller.

4. The process of claim 2, wherein the smooth roller and the planetary roller have a substantially equal outside diameter and a main cylinder of the planetary roller has in comparison with planetary cylinders of the planetary roller a diameter that is at least three times as large and at most seven times as large.

5. The process of claim 1, wherein a series of rollers at least three and at most six pairs of rollers arranged directly one behind the other are provided, consisting of a smooth roller and a planetary roller.

6. The process of claim 1, wherein two series of rollers arranged mirror-symmetrically about a middle plane of the scattering head are provided, the material inflow unit is arranged centrally in relation to the middle plane of the scattering head and the series-of-rollers conveying direction and the direction of rotation of the conveying rollers are directed outwardly, as seen from the material inflow unit.

7. The process of claim 1, wherein a porcupine roller with at least 1000 and at most 1500 radial spikes is provided as a first conveying roller of the series of rollers, an effective circle of the porcupine roller being at least 50% greater and at most twice as great as an effective circle or diameter of the other conveying rollers and a proportion on the effective circle of at least 20% and at most 30% being assignable to the radial spikes.

8. The process of claim 1, wherein one or more series of rollers is underlaid by a series of paddle wheels with paddle wheels directly adjacent one another, the paddle wheels comprising transverse pockets extending parallel to a paddle wheel axis, which are respectively formed by two V-shaped paddles and part of a lateral surface of a cylinder roller, each paddle being oriented with an open side of the V-shaped paddle in the direction of rotation and connected with one end at an acute angle to the lateral surface of the cylinder roller.

9. The process of claim 1, wherein only one layer of kraft paper is applied directly to an untreated surface of the unworked panel and is bonded to the surface by hot pressing or in that a surface of the unworked panel is sanded by at least 0.1 mm and at most 2 mm and at least one layer of kraft paper is applied directly to the sanded surface and is bonded to the surface by hot pressing.

10. A panel, wherein the panel provides stalks of one or more cereal crops that are for the greatest part split into stalk half shells exclusively as the fiber material, the stalk half shells having a length of less than 4 mm to a proportion of at most 80%, the panel having a density of at least 400 kg/m³ and at most 950 kg/m³.

11. Panel of claim 10, wherein the stalk half shells having a length of less than 4 mm to a proportion of at least 40%.

12. Panel of claim 10, wherein the panel having a density distribution in the longitudinal extent with a standard deviation of at most 20%.

13. Panel according to claim 10, wherein the panel has exclusively one of straw as the fiber material, reed as the fiber material, a mixture of straw with a proportion of reed of at least 10% and at most 40%, and a density of at least 520 kg/m³, for use for load-bearing applications.

14. Panel according to claim 10, wherein the panel has one to at most three layers of kraft paper directly on an untreated surface.

15. Panel according to claim 10, wherein the panel has only one layers of kraft paper directly on an untreated surface.

16. Panel according to claim 10, wherein the panel has one to at most three layers of kraft paper directly on a surface sanded by at most 2 mm.

17. Panel according to claim 16, wherein the panel comprises a surface with decoration produced by color pigments.

18. Panel according to claim 16, wherein the panel has only one layers of kraft paper directly on a surface sanded by at most 2 mm.

19. A scattering head for scattering elongate stalk half shells from a cereal crop onto a conveyor belt for producing a panel, the scattering head comprising
a material inflow unit and
a series of rollers with conveying rollers arranged one behind the other,
wherein the conveying rollers alternately have a rotationally symmetrical lateral surface and a non-rotationally symmetrical lateral surface with depressions or elevations.

20. An outer-layer scattering head for scattering elongate stalk half shells from a cereal crop onto a conveyor belt for producing a panel, the outer-layer scattering head comprising
a material inflow unit and
at least one series of spindles arranged one behind the other,
wherein a number of series of spindles are arranged one above the other in the form of a pyramid and centrally under the material inflow unit and only a single, common unitary spindle-rotating direction of all the spindles of the outer-layer scattering head is provided.
